(19) United States
(12) Patent Application Publication
(10) Pub. No.: US 2010/0329766 A1
(43) Pub. Date: Dec. 30, 2010

(54) DEVICE AND METHOD FOR PRINTING BANNER MEDIA

(76) Inventors: Daniel Paul Cahill, Verona, KY (US); Thomas Leo Miller, Redmond, KY (US); Chad Michael Piening, Lexington, KY (US); Lovann Behymer Samuels, Georgetown, KY (US); Curtis Duane Woodson, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/492,240

(22) Filed: Jun. 26, 2009

(51) Int. Cl. B41J 15/00

(52) U.S. Cl. 400/613

(57) ABSTRACT

An apparatus and method for printing banner media utilizing a conventional laser printer wherein no or substantially no modification is required to the paper tray of the laser printer. The apparatus further includes a storage compartment that can be operably coupled with the paper tray. Disposed within the storage compartment is a plurality of rotatably mounted spools having a banner media stored thereon. Additionally, an alternative method of configuring banner media in a conventional paper tray is provided whereby the banner print media is configured in one of a z-fold configuration and a modified z-fold configuration, with the modified z-fold configuration to inhibit creases in the banner print media.

### CROSS REFERENCES TO RELATED APPLICATIONS

Not Applicable.

### STATEMENT REGARDING FEDERALLY SPONSORED RESEARCH OR DEVELOPMENT

Not Applicable.

### REFERENCE TO SEQUENTIAL LISTING, ETC.

Not Applicable.

### BACKGROUND

1. Field of the Invention

The present invention relates generally to printing methods and an apparatus for printing media, more specifically but not by way of limitation, to an apparatus and method for printing banner media utilizing a conventional printer.

2. Description of the Related Art

Many printing applications for conventional laser or inkjet printers utilize standard cut media such as 8.5×11 paper stored in conventional integral printer trays that allow the media to be fed into the printer when a printing job is requested. However, numerous applications exist wherein a user desires to print on media that is greater in length than the standard cut media. Commonly referred to as banner media, this media is greater in length than 11 inches and can reach lengths of least 48 inches or greater. Conventional paper trays for standard printers have shown to have difficulty in accommodating banner media.

Many retailers produce documents such as but not limited to shelf marking labels and other documents, forms or posters that are best suited for printing on banner media. One issue with current banner media printing methods is that conventional printers require expensive and time consuming modifications and customization to the printer tray in order to accommodate banner media and accomplish the printing task. The modification of the printer tray increases the footprint of the printer thereby limiting where the printer can be physically located. Additionally, existing methods of printing banner media require the media to be placed in a generally horizontal position extending outward from the printer and superposed on an unobstructed horizontal support surface such as a countertop that provides substantial support to the entire length of the banner media. The banner media required for these current methods must also be stored in such a manner as to protect the physical integrity of the banner media. In order to achieve this, additional storage space is required to store the banner media. This creates a burden not only for a retailer that has limited space but suppliers of these products also must maintain adequate storage space to accommodate the banner media.

Current methods of printing banner media have been shown to be extremely cumbersome with the loading and handling of the banner media being very difficult. Expensive media, such as vinyl or polyester type material can be damaged. The space required to use this method is cost prohibitive to retailers that must control their cost per square foot or have limited space available.

Accordingly, there is a need for an apparatus and a method allowing a user to print banner media utilizing a standard printer tray integrated with a conventional printer. Additionally, the apparatus should contain at least one banner media and be able to be operably disposed within the printer tray with little or no modification to the tray so as to facilitate the printing of the banner media. Furthermore, the apparatus should accommodate a plurality of methods of loading more than one banner media.

### SUMMARY OF THE INVENTION

In accordance with one embodiment of the present invention, there is provided a banner media cassette to facilitate the printing of banner media using a standard printer. The printer tray has no substantial modification thereto in order to receive therein the banner media cassette. The banner media cassette may include a housing that is configured to store a plurality of banner media. The housing is further configured to be integrally disposed into a standard printer tray of a printer. The banner media disposed within the banner media cassette is rolled around on at least one spool that is rotatably mounted within the banner media cassette. The banner media contained within the banner media cassette is configured to have its leading edge placed adjacent to the wear strips located in printer tray. Wherein subsequent the request of a print command being sent to the printer, the leading edge is engaged by at least one pick tire in order to advance the banner media into the print path of the printer thereby commencing the print task. The banner media cassette further includes a housing that can be manufactured from molded pulp material which is a sustainable packaging material as it is manufactured from recycled products and can be recycled again after its useful life.

In accordance with another embodiment of the present invention, a method of printing banner media utilizing a conventional printer and paper tray is provided. The method includes placing at least one banner media substantially within the printer paper tray in a folded arrangement such that the tray can accommodate more than one banner media. The method further includes folding the banner media using a vertical z-fold pattern to facilitate the loading of a plurality of banner media into a conventional printer paper tray. The banner media is disposed within the printer paper tray in a z-fold pattern such that the banner media's leading edge is placed adjacent to the wear strips located within the printer tray. Subsequent to the print command being delivered to the printer the pick tires that are adjacent to the aforementioned leading edge would advance the topmost leading edge of the banner media into the printer.

According to yet another embodiment of the present invention, a method of printing a plurality of banner media utilizing a conventional printer paper tray is provided. The method comprises loading a printer paper tray with a plurality of banner media, each banner media having a leading edge that is placed proximate the wear strips located within the printer tray. The method further includes folding the banner media in a modified z-fold type configuration such that the angle of the folds of the banner media are of an appropriate angle so as to substantially reduce any crease or fold marks in the banner media. Subsequent to the print command being delivered to the printer the pick tires that are adjacent to the aforementioned leading edge would advance the topmost leading edge of the banner media into the printer.

To the accomplishment of the above features and characteristics, the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 illustrates a diagrammatic view of a conventional printer illustrating an embodiment of the present invention and the loading of the z-fold printing media and the print path;

FIG. 2 illustrates a diagrammatic view of a conventional printer showing another embodiment of the present invention and the loading of the modified z-fold printing media and the print path;

FIG. 3 illustrates a perspective view of an embodiment of the present invention having spooled printing media disposed therein;

FIG. 4 illustrates a perspective view of an embodiment of the present invention having the spools for supporting the printing media disposed therein; and

FIG. 5 illustrates a perspective view of an embodiment of the present invention wherein the present invention containing the spooled media is disposed within a conventional printer paper tray.

### DETAILED DESCRIPTION

Referring now to the drawings submitted herewith, wherein various elements depicted therein are not necessarily drawn to scale and wherein through the views and figures like elements are referenced with identical reference numerals, there is illustrated throughout several embodiments according to the principles of the present invention. It is to be understood that the invention is not limited in its application to the details of construction and the arrangement of components set forth in the following description or illustrated in the drawings. The invention is capable of other embodiments and of being practiced or of being carried out in various ways. Furthermore, it is to be understood that the phraseology and terminology used herein is for the purpose of description and should not be regarded as limiting. The use of “including”, “comprising” or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings.

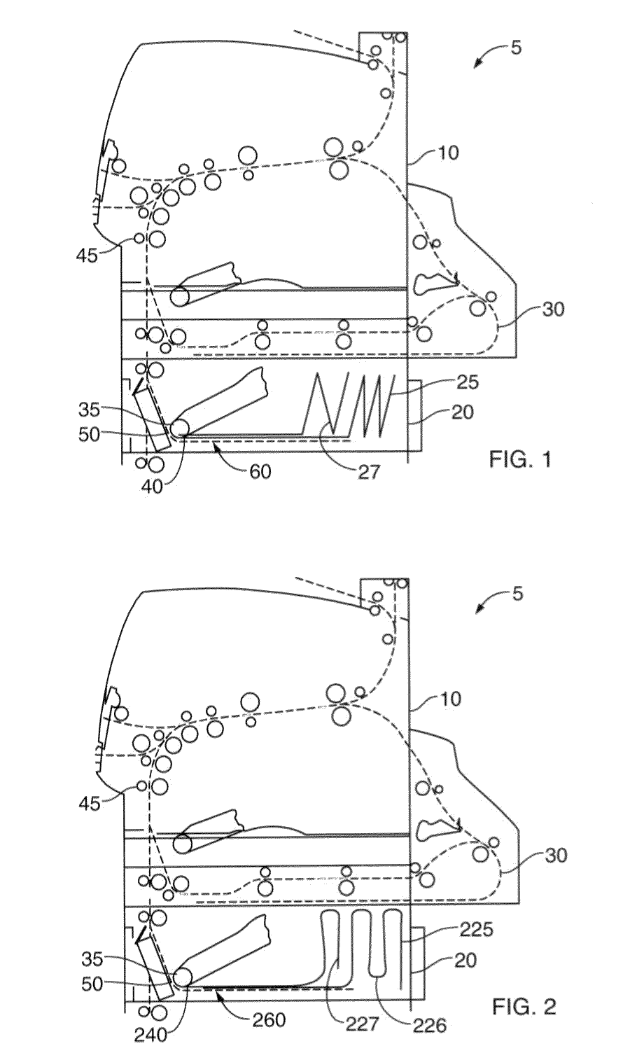

In particular, FIG. 1 shows a laser printer 5 that includes a housing 10 typically manufactured from a plastic material. A paper tray 20 configured to receive standard paper therein, such as standard letter size or legal paper size, is removably and operably coupled to the housing 10 and has an interior volume for storing print media 25. The print media 25 may be any type of suitable material such as but not limited to transparencies, paper, card-stock, mylar and other similar materials. The print media 25 is fed into the print path 30 utilizing at least one pick tire 35 that is adjacent to the leading edge 40 of the print media 25. Although not shown, the laser printer 5 includes a printer controller that receives commands from a computer or other similar device. Subsequent to a command being received by the print controller, the print job begins and the pick tire 35 advances at least one sheet of print media 25 into the print path 30. Configured along print path 30 are plurality of rollers or wheels 45 and other similar components that will manipulate the print media through the print path while print material, such as toner, is deposited on the print media 25 in the desired locations. Methods for moving media along a print path and for depositing toner or ink on media are well known and as a result will not be discussed in further detail for reasons of simplicity.

In accordance with one embodiment of the present invention, a method for printing media longer than the conventional letter size or legal size media utilizing a standard printer configuration and paper tray is provided. The print media 25 and 27 disposed within a conventional print tray 20 are forty-eight inch long pieces of banner media. The print media 25 and 27 are folded back onto themselves and one another such that the resemblance from the side view is that of a z-shape or an accordion like fold. The print media 25 and 27 are oriented in the paper tray 20 in a generally vertical position. Each of the print media 25 and 27 has a leading edge that is proximate the wear strips 50. The leading edge 40 of each of the print media 25 and 27 disposed within the paper tray 20 is extended towards the pick tire 35 and to create a stack 60 that is aligned such that the print media 27 closest to the pick tire 35 has its leading edge 40 on top of the print media 25 and is adjacent to the pick tire 35. The leading edges 40 of the remaining print media 25 are stacked underneath. The leading edge 40 of the topmost print media 27 is advanced into the print path 30 subsequent a command from the printer controller to print on the forty-eight inch length print media 27. It is contemplated that little or no hardware modifications are necessary to the printer 5 in order to accommodate print media 25 and 27. Additionally, the code of the printer controller is setup so as to program the printer 5 with the corresponding length of the print media 25 and 27 that is being utilized.

As the pick tire 35 advances the topmost sheet of the print media 27, the leading edge 40 of the print media 25 that was directly underneath the formerly topmost sheet of print media is frictionally moved into position such that the leading edge 40 is now proximate the pick tire 35 and will be the next sheet of print media 25 to be advanced into the print path 30 subsequent a print command being generated or received by the printer controller. The z-fold design of the print media 25 and 27 allows a plurality of print media to be loaded into a conventional laser printer paper tray 20 with little or no specialized tooling or re-modifications to the paper tray 20. It is contemplated that one or more than one sheets of print media having a z-fold configuration could be loaded into the paper tray 20 of the printer 5. Those skilled in the art will also recognize that although embodiments of the present invention are described utilizing print media that is forty-eight inches in length it should be recognized that the banner print media could be any length as needed or desired by a user. Additionally, it is contemplated that each of the banner print media disposed in the paper tray could be of varying length.

It is further contemplated that a banner media cassette could be provided that has a plurality of z-fold banner media pre-loaded therein. The banner media cassette would be configured to be operably disposed within the paper tray 20 with no or substantially no modifications thereto so as to provide a user a method of loading more than one banner media at a time or eliminating the need for the user to fold the media themselves.

Referring now to FIG. 2, there is illustrated an alternative embodiment of the present invention as similarly show in FIG. 1. In this particular embodiment the banner print media 225 and 227 are disposed within the print tray in a modified z-fold pattern. In particular each of the banner media 225 and 227 are folded back onto themselves and one another such that the resemblance from the side view is that of a modified z-shape or an accordion like fold. The folds 226 are created in such a manner to substantially reduce or eliminate crease in the print media 225 that may be caused in a standard z-fold pattern. Those skilled in the art will recognize that the fold 226 could be folded in numerous different angles to achieve the objective as described herein.

As similarly shown and described in reference to the embodiment of FIG. 1, the banner print media 225 and 227 is folded and oriented within the paper tray 20 such that it is a generally vertical position. The leading edges 240 of each of the banner print media are disposed within the paper tray 20 is extended towards the pick tire 35 and to create a stack 260 that is aligned in a manner such that the banner print media closest to the pick tire 35 has its leading edge 240 adjacent to the pick tire 35 and the leading edges 240 of the remaining banner print media are stacked underneath. The leading edge 240 of the topmost banner print media is advanced into the print path 30 subsequent a command from the printer controller to print on the forty-eight inch length print media. It is contemplated that little or no modifications are necessary to the printer 5 in order to accommodate print media 225 and 227. Additionally, the code of the printer controller is set up so as to program the printer 5 with the corresponding length of the print media 225 and 227 that is being utilized.

As the pick tire 35 advances the topmost sheet of the print media, the leading edge 240 of the print media that was directly underneath the formerly topmost sheet of print media is now positioned such that its leading edge 240 is proximate the pick tire 35 and will be the next sheet of print media to be advanced into the print path 30 subsequent a print command being generated or received by the printer controller. The modified z-fold design of the banner print media 225 and 227 allows a plurality of print media to be loaded into a conventional paper tray 20 without the need for any specialized tooling or re-modifications to the paper tray 20.

It is further contemplated that a banner media cassette could be provided that has a plurality of modified z-fold banner media pre-loaded therein. The banner media cassette would be configured to be operably disposed within the paper tray 20 with no or substantially no modifications thereto so as to provide a user a method of loading more than one banner media of equal or varying lengths at a time or eliminating the need for the user to fold the media themselves.

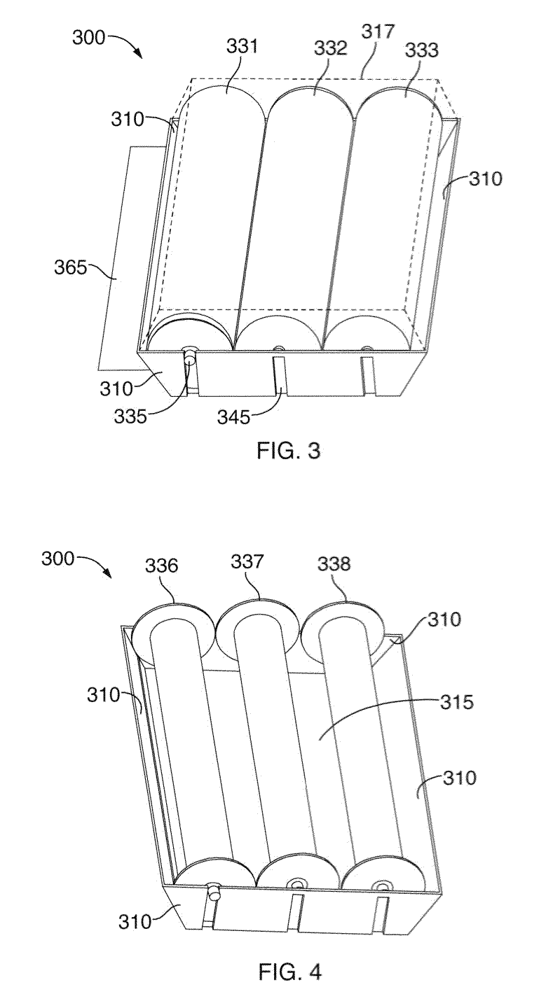

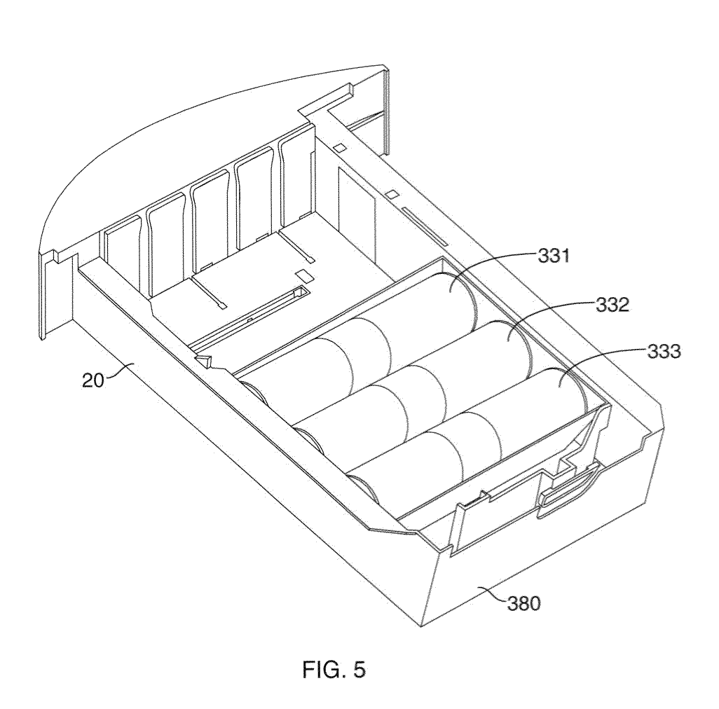

Referring now to FIGS. 3, 4 and 5 there is illustrated another embodiment of the present invention for printing on media longer than conventional letter or legal size is provided, more specifically but not by way of limitation a forty-eight inch or thirty-three inch banner media. A media cassette 300 containing spools 331, 332 and 333 of banner print media in accordance with the principles of the present invention is shown. The media cassette 300 further includes walls 310, a bottom 315 and a top 317 being configured to have an interior volume to receive spools 331, 332 and 333 therein. The top 317 is releasably secured to the walls 310 using suitable mechanical or chemical methods. The top can be removable so as to provide a user access to the spools 331, 332 and 333. The media cassette 300 is manufactured from suitable durable material such as but not limited to molded pulp materials. Molded pulp is material manufactured from one hundred percent recycled corrugated fiberboard and newspaper. The banner print media of spools 331, 332 and 333 is of a suitable type such as but not limited to paper, transparencies, mylar, card-stock, poster material, vinyl media or polyester media. The banner print media of spools 331, 332 and 333 is rolled on cores 336, 337 and 338 of spools 331, 332 and 333 respectively. Each of the banner print media of spools 331, 332 and 333 has a leading edge 365 that is extended from the spools and stacked with the leading edge of spool 331 being on top, the leading edge of spool 332 next, and the edge of spool 333 being on the bottom of the stack.

The cores 336, 337 and 338 are manufactured from a suitable durable material and function to provide support for the banner print media rolled thereon. Each of the cores 336, 337 and 338 have pins, such as pin 335 on each end which operably engage with the slots 345 of walls 310 of the media cassette 300. The slots 345 function to allow the spools 331, 332 and 333 to rotate and further function to substantially reduce any non-desired movement of the spools within the media cassette 300. The pins 335 function to allow the spools 331, 332 and 333 to rotate within the media cassette 300 so as to dispense the print media contained thereon while maintaining a substantially stationary position in the media cassette 300.

As shown in particular in FIG. 5, the media cassette 300 is manufactured such that it can be substantially disposed within a conventional laser or inkjet paper tray 20 with little or no modifications or re-tooling of the paper tray required. Once the media cassette 300 is loaded into the paper tray 20, and the leading edges 365 from each of the banner print media of spools 331, 332 and 333 have been stacked and properly aligned opposite end 380, the paper tray 20 is inserted into the printer. Utilizing the media cassette 300 within the paper tray 20 allows the footprint of the printer 5 to remain the same regardless of the type and length of media loaded for printing.

The banner print media from spool 331 furthest from the end 380 will have its leading edge 365 placed at the top of the stack of leading edges 365 so that the banner print media stored on the first spool 331 will be fed into the printer 5 first. Once the banner print media of spool 331 is depleted, the banner print media from the second spool 332 will be fed into the printer subsequent a print task being received from the printer controller. This process will continue until all of the banner print media from the spools disposed within the paper tray 20 has been consumed. It is contemplated that the spools 331, 332 and 333 are capable of supporting and having rolled sheet of banner print media longer than forty-eight inches.

Although embodiments of the present invention are described herein as having three spools 331, 332 and 333, it is contemplated that any number of spools could be configured to be stored within the media cassette 300. Additionally, it is contemplated that lengths of banner print media other than the 33 or 48 inch lengths could also be utilized. It is further contemplated that a user could utilize more than one media cassette 300 in order to accomplish a particular printing task.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A printer comprising:
a paper tray configured to receive paper therein, the paper tray further configured to be removably inserted into the printer;
a media cassette having a plurality of walls defining a cavity therein, the media cassette for receiving banner print media within the cavity, said media cassette configured to be at least partially disposed within the paper tray and further configured to deliver the banner print media to the printer when the paper tray and the media cassette are inserted into the printer.

2. The printer as recited in claim 1, and further comprising at least one spool disposed within the cavity of the media cassette, the at least one spool having the banner print media disposed thereon.

3. The printer as recited in claim 1, and further comprising at least one spool disposed within the cavity of the media cassette, the at least one spool configured to have the banner print media disposed thereon.

4. The printer as recited in claim 3, wherein said media cassette further includes a first slot disposed on a first of the plurality of walls and a second slot disposed on a second of the plurality of walls, said first slot and said second slot configured to the at least one spool.

5. The printer as recited in claim 1, and further including at least 3 spools disposed within the cavity of the media cassette, with each of the 3 spools configured to have banner print media disposed thereon.

6. The printer as recited in claim 1, wherein said media cassette is manufactured from a molded pulp material.

7. The printer as recited in claim 6, wherein the banner media disposed within said media cassette is selected from one of the following lengths of banner media: forty-eight inch banner media or thirty-three inch banner media.

8. A banner print media cassette for insertion into a conventional paper tray of a laser printer comprising:
a plurality of walls and a bottom configured to form a cavity, the cavity configured to receive at least one rolled banner print media therein; and
a removable top for placement over at least a portion of the cavity.

9. The banner print media cassette as recited in claim 8, wherein the plurality of walls and the bottom are configured to be inserted into the conventional paper tray of the laser printer.

10. The banner print media cassette as recited in claim 9, wherein the at least one rolled banner print media is rotatably mounted within the cavity to a first and a second of the plurality of walls.

11. The banner print media cassette as recited in claim 10, wherein the first and second of the plurality of walls each include a slot for receiving the at least one rolled banner print media.

12. The banner print media cassette as recited in claim 11, wherein the cavity is further configured for receiving at least two rolled banner print media, with the second rolled banner print media positioned adjacent the first rolled banner print media.

13. The banner print media cassette as recited in claim 12, wherein the first and second rolled banner print media are each rotatably mounted within the cavity to the first and the second of the plurality of walls.

14. The banner print media cassette as recited in claim 13, wherein each of the first and second rolled banner print media banner are disposed on spools. A printer comprising:
a paper tray with at least a portion insertable within the printer, the paper tray configured to receive therein at least one of letter and legal size paper; and
at least one banner print media positioned in the paper tray such that the paper tray is operable to deliver the at least one banner print media to the printer for printing thereon when at least a portion of the paper tray is inserted within the printer.

15. The printer as recited in claim 15, wherein at least a portion of said at least one banner print media is folded in a z-fold configuration.

16. The printer as recited in claim 15, wherein at least a portion of said at least one banner print media is folded in an accordion configuration and further configured to inhibit creases in the banner print media.

17. The printer as recited in claim 15, and further including at least a second banner print media placed in the paper tray adjacent said at least a first banner print media.

18. The printer as recited in claim 18, wherein each of said first and second banner print media are folded in a z-fold configuration.

19. The printer as recited in claim 18, wherein each of said first and second banner print media are folded in at least one of a z-fold configuration and an accordion configuration to inhibit creases in the banner print media.
